(19) United States
(12) Patent Application Publication
(10) Pub. No.: US 2024/0386292 A1
(43) Pub. Date: Nov. 21, 2024

(54) INTELLIGENT, OPTIMAL SERVICE DISPATCH DURATION COMPUTATION

(71) Applicant: Dell Products L.P., Round Rock, TX (US)

(72) Inventors: Bijan Kumar Mohanty, Austin, TX (US); Hung Dinh, Austin, TX (US); Mila Ghosh, Ashland, MA (US)

(73) Assignee: Dell Products L.P., Round Rock, TX (US)

(21) Appl. No.: 18/319,678

(22) Filed: May 18, 2023

(51) Int. Cl. G06N 5/022

(52) U.S. Cl. CPC G06N 5/022

(57) ABSTRACT

An example methodology includes, by a computing device, receiving information regarding a field service dispatch from another computing device and determining one or more relevant features from the information regarding the field service dispatch, the one or more relevant features influencing prediction of a dispatch duration. The method also includes, by the computing device, generating, using a machine learning (ML) model, a prediction of a dispatch duration for the field service dispatch based on the determined one or more relevant features, and sending the prediction of the dispatch duration for the field service dispatch to the computing device.

### BACKGROUND

Organizations, such as companies that manufacture and/or sell products, find themselves in endless pursuit to provide industry leading, best-in-class product support experience for their customers. Poor product service can result in customer dissatisfaction and, in some cases, loss of customer loyalty. Poor quality service can also lead to increased product returns and support issues, which can negatively impact organizations who manufacture and/or sell such products. For example, many sellers of high-technology products (e.g., computers, appliances, electronic devices, etc.) need to provide on-time support for their products to be successful in their business and win customer loyalty.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving information regarding a field service dispatch from another computing device and determining one or more relevant features from the information regarding the field service dispatch, the one or more relevant features influencing prediction of a dispatch duration. The method also includes, by the computing device, generating, using a machine learning (ML) model, a prediction of a dispatch duration for the field service dispatch based on the determined one or more relevant features, and sending the prediction of the dispatch duration for the field service dispatch to the computing device.

In some embodiments, the ML model includes a deep neural network (DNN). In one aspect, the DNN predicts a regression response, wherein the regression response is the prediction of the dispatch duration for the field service dispatch.

In some embodiments, the ML model is generated using a training dataset generated from a corpus of historical field support data of an organization.

In some embodiments, the training dataset comprises a plurality of training/testing samples, wherein each training/testing sample of the plurality of training/testing samples includes one or more features extracted from the historical field support data, wherein the one or more features includes a feature indicative of a customer associated with the field service dispatch.

In some embodiments, the training dataset comprises a plurality of training/testing samples, wherein each training/testing sample of the plurality of training/testing samples includes one or more features extracted from the historical field support data, wherein the one or more features includes a feature indicative of a type of product associated with the field service dispatch.

In some embodiments, the training dataset comprises a plurality of training/testing samples, wherein each training/testing sample of the plurality of training/testing samples includes one or more features extracted from the historical field support data, wherein the one or more features includes a feature indicative of a type of support associated with the field service dispatch.

In some embodiments, the training dataset comprises a plurality of training/testing samples, wherein each training/testing sample of the plurality of training/testing samples includes one or more features extracted from the historical field support data, wherein the one or more features includes a feature indicative of a support location associated with the field service dispatch.

In some embodiments, the training dataset comprises a plurality of training/testing samples, wherein each training/testing sample of the plurality of training/testing samples includes one or more features extracted from the historical field support data, wherein the one or more features includes a feature indicative of a field support engineer associated with the field service dispatch.

In some embodiments, the training dataset comprises a plurality of training/testing samples, wherein each training/testing sample of the plurality of training/testing samples includes one or more features extracted from the historical field support data, wherein the one or more features includes a feature indicative of a type of trip associated with the field service dispatch.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a block diagram of an illustrative system for intelligent service dispatch management, in accordance with an embodiment of the present disclosure.

FIG. 5 is a diagram illustrating a portion of a data structure that can be used to store information about relevant features of a training dataset for training a machine learning (ML) model to predict a dispatch duration for a field service dispatch, in accordance with an embodiment of the present disclosure.

FIG. 6 is a diagram illustrating an example architecture of a deep neural network (DNN) for a service dispatch management module, in accordance with an embodiment of the present disclosure.

FIG. 7 is a diagram showing an example topology that can be used to predict a dispatch duration for a field service dispatch, in accordance with an embodiment of the present disclosure.

FIG. 8 is a flow diagram of an example process for prediction of a dispatch duration for a field service dispatch, in accordance with an embodiment of the present disclosure.

### DETAILED DESCRIPTION

Good product service can help organizations build trust with customers, increase market share, and drive sales. While some products can be serviced remotely, support for many high-technology products requires scheduling of a field technician/engineer dispatch to the customer location to provide the support. For example, appointments for field service dispatches may be booked in an organization's field service management platform. A scheduled dispatch is typically for a time duration with a scheduled start time and end time. However, existing field service management systems use static, heuristic or rules-based approaches to calculate a duration for the scheduled field service dispatch. These static, heuristic/rules-based approaches usually apply a best-case scenario in calculating the dispatch duration. As a result, the calculated dispatch duration is often either too short or too long, resulting in complexities in scheduling and other repercussions for the organization. For example, too short a dispatch duration can result in a second dispatch and a return trip to the customer location. Too short a dispatch duration can also result in the scheduled dispatch extending into other dispatches scheduled after the current dispatch, which can result in cancellation of scheduled dispatch appointments. Both results are operationally expensive and can negatively impact customer satisfaction. Similarly, too long a dispatch duration can result in wastage of field technician time and increase the support operation cost, thus impacting the organization's profit margins.

It is appreciated that the actual time needed to provide support for a product can vary depending on a variety of factors including, for example, the product being supported, type of support needed (e.g., break/fix, installation, recertification etc.), part(s) being replaced (if any), the field technician/engineer scheduled to provide the support and their skills, whether the dispatch is a first trip or a return trip, etc. It is also appreciated that the duration of a field service dispatch to provide support for a product can similarly vary depending on the above-mentioned factors.

Disclosed herein are computer-implemented structures and techniques for intelligent service dispatch management. Intelligent management can be achieved using a data driven approach to estimate the duration of a field service dispatch to support a specific issue/event by a particular field resource (e.g., a field service engineer). According to some embodiments, a machine learning (ML) model is leveraged to predict a dispatch duration for a field service dispatch. For example, a training dataset can be generated from an organization's historical field support data. It is appreciated that historical field support data is a good indicator for estimating the future field support timelines of customers with high accuracy. The historical field support data includes information about the historical field service dispatches, such as, product being supported, type of support, customer and location of the support, parts being replaced/fixed, the field engineer's expertise, and the field engineer's history in providing the specific support, among other information. The training dataset can be used to train an ML algorithm, such as a neural network-based regression algorithm, where the training can configure the ML model to learn trends in the training data. Once trained, the regression-based ML model can, in response to input of information about a new field service dispatch for a customer, predict a dispatch duration for the new field service dispatch. The concepts, structures, and techniques described herein can be used to improve the efficiency and utility of existing computer systems, such as field service management systems that provide scheduling of field service dispatches. Numerous configurations and variations will be apparent in light of this disclosure.

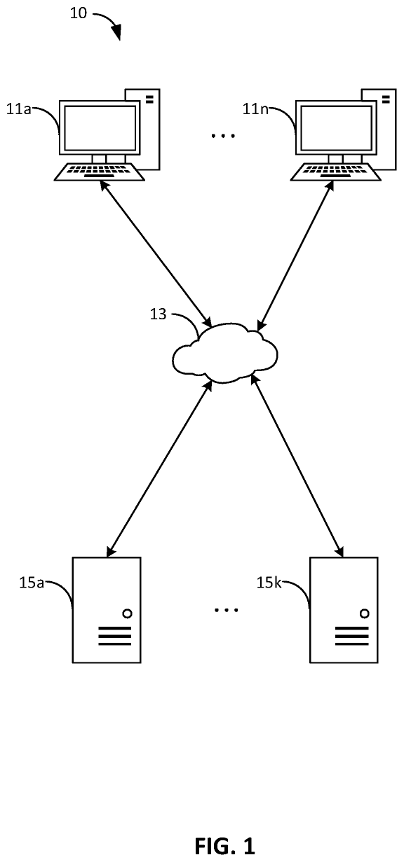

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

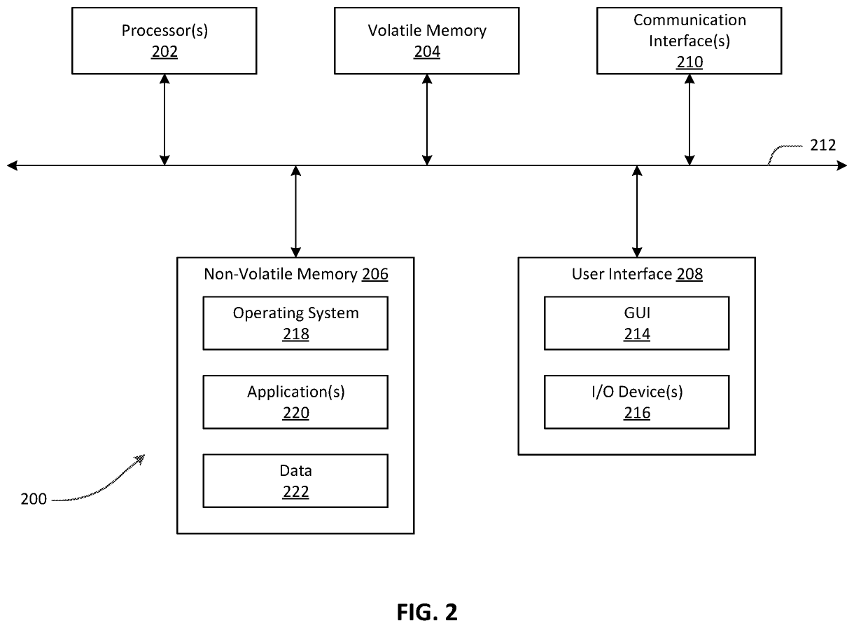

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

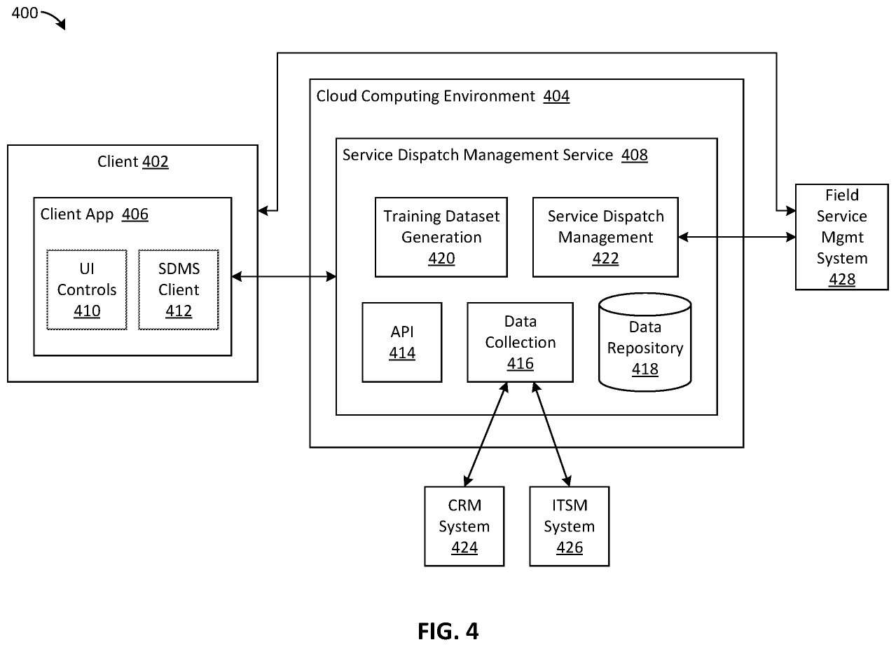

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

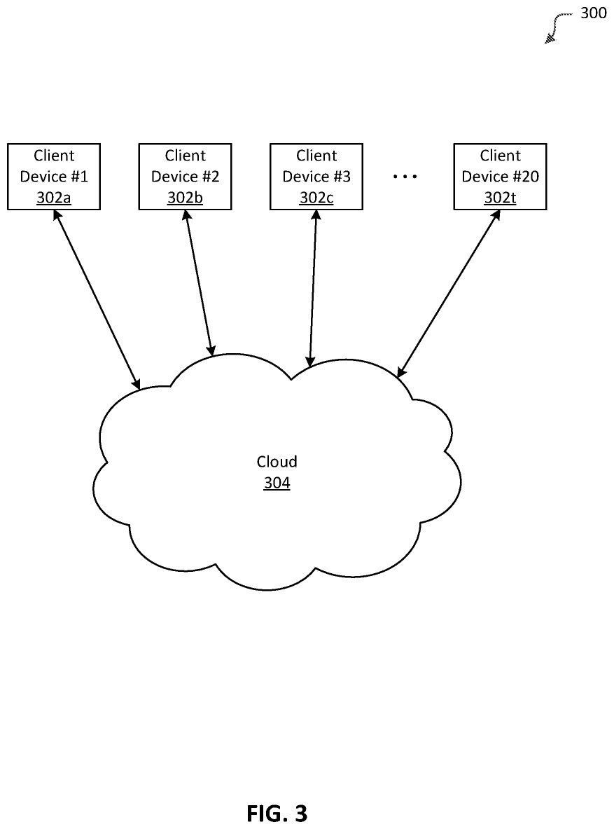

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a block diagram of an illustrative system 400 for intelligent service dispatch management, in accordance with an embodiment of the present disclosure. Illustrative system 400 includes a client application 406 operable to run on a client 402 and configured to communicate with a cloud computing environment 404 via one or more computer networks. Client 402 and cloud computing environment 404 of FIG. 4 can be the same as or similar to client 11 of FIG. 1 and cloud computing environment 300 of FIG. 3, respectively.

As shown in FIG. 4, a service dispatch management service 408 can be provided as a service (e.g., a microservice) within cloud computing environment 404. For example, an organization such as a company, an enterprise, or other entity that manufactures and/or sells products (e.g., high-technology products such as computers, appliances, electronic devices), for instance, may implement and use service dispatch management service 408 to predict dispatch durations for field service dispatches (e.g., new field service dispatches being scheduled for customers). Client application 406 and service dispatch management service 408 can interoperate to provide intelligent service dispatch management, as variously disclosed herein. To promote clarity in the drawings, FIG. 4 shows a single client application 406 communicably coupled to service dispatch management service 408. However, embodiments of service dispatch management service 408 can be used to service many client applications (e.g., client applications 406) running on client devices (e.g., clients 402) associated with one or more organizations and/or users. Client application 406 and/or service dispatch management service 408 may be implemented as computer instructions executable to perform the corresponding functions disclosed herein. Client application 406 and service dispatch management service 408 can be logically and/or physically organized into one or more components. In the example of FIG. 4, client application 406 includes UI controls 410 and a service dispatch management service (SDMS) client 412. Also, in this example, service dispatch management service 408 includes an application programming interface (API) module 414, a data collection module 416, a data repository 418, a training dataset generation module 420, and a service dispatch management module 422.

The client-side client application 406 can communicate with the cloud-side service dispatch management service 408 using an API. For example, client application 406 can utilize SDMS client 412 to send requests (or “messages”) to service dispatch management service 408 wherein the requests are received and processed by API module 414 or one or more other components of service dispatch management service 408. Likewise, service dispatch management service 408 can utilize API module 414 to send responses/messages to client application 406 wherein the responses/messages are received and processed by SDMS client 412 or one or more other components of client application 406.

Client application 406 can include various UI controls 410 that enable a user (e.g., a user of client 402), such as a service dispatch associate or manager or other associate within or associated with an organization, to access and interact with service dispatch management service 408. For example, UI controls 410 can include UI elements/controls, such as input fields and text fields, with which the user can specify details about a field service dispatch (e.g., a new field service dispatch for a customer). The specified field service dispatch may be, for example, being scheduled for the customer by the organization. The details about the field service dispatch may include information such as, for example, the customer associated with the field service dispatch, the product being supported, the type of support being provided, and the location where the product support is to be provided. In some implementations, some or all the UI elements/controls can be included in or otherwise provided via one or more electronic forms configured to provide a series of fields where data is collected, for example. UI controls 410 can include UI elements/controls that a user can click/tap to request an estimate of a dispatch duration for the specified field service dispatch. In response to the user's input, client application 406 can send a message to service dispatch management service 408 requesting an estimate of a dispatch duration for the specified field service dispatch.

Client application 406 can also include UI controls 410 that enable a user to view a predicted dispatch duration for a field service dispatch. For example, in some embodiments, responsive to sending a request for an estimate of a dispatch duration for a field service dispatch, client application 406 may receive a response from service dispatch management service 408 which includes a prediction of a dispatch duration for the specified field service dispatch. UI controls 410 can include a button or other type of control/element for displaying the prediction included in the response from service dispatch management service 408, for example, on a display connected to or otherwise associated with client 402. The user can then take appropriate action based on the provided prediction. For example, the user can schedule a field service dispatch for the customer for the predicted dispatch duration. For example, according to some embodiments, UI controls 410 can also include UI elements/controls for accessing and interacting with a field service management system 428. Field service management system 428 can correspond to a system used by the organization to organize and manage field service activities (e.g., schedule, dispatch, and track field resources). In such embodiments, the user can use the provided UI elements/controls to access and use field service management system 428 to book a field service dispatch for the customer.

In the embodiment of FIG. 4, client application 406 is shown as a stand-alone client application. In other embodiments, client application 406 may be implemented as a plug-in or extension to another application on client 402, such as, for example, a field support system client application or a customer relationship management (CRM) client application. In such embodiments, UI controls 410 may be accessed within the other application in which client application 406 is implemented (e.g., accessed within the field support system client application or the CRM client application).

Referring to the cloud-side service dispatch management service 408, data collection module 416 is operable to is operable to collect or otherwise retrieve the organization's historical field support data along with other information about the organization's historical field service dispatches from one or more data sources. The data sources can include, for example, a customer relationship management (CRM) system 424 and an information technology service management (ITSM) system 426. The historical field support data includes information about the historical field support dispatches made by the organization to provide product support for customers. Data collection module 416 can store the historical field support data along with other information about the organization's historical field service dispatches collected from the various data sources within data repository 418, where it can subsequently be retrieved and used. For example, the historical field support data and other materials from data repository 418 can be retrieved and used to generate a training dataset for use in generating an ML model (e.g., a regression-based ML model). In some embodiments, data repository 418 may correspond to a storage service within the computing environment of service dispatch management service 408.

Data collection module 416 can utilize application programming interfaces (APIs) provided by the various data sources to collect information and materials therefrom. For example, data collection module 416 can use a Representational State Transfer (REST)-based API or other CRM API provided by CRM system 424 to collect information therefrom (e.g., to collect the historical field support data). As another example, data collection module 416 can use a REST-based API or other ITSM API provided by ITSM system 426 to collect information therefrom. A particular data source (e.g., CRM system 424 and/or ITSM system 426) can be hosted within a cloud computing environment (e.g., the cloud computing environment of service dispatch management service 408 or a different cloud computing environment) or within an on-premises data center (e.g., an on-premises data center of an organization that utilizes service dispatch management service 408).

In cases where a data source does not provide an interface or API, other means, such as printing and/or imaging, may be utilized to collect information therefrom (e.g., generate an image of printed document containing information/data about a historical field service dispatch). Optical character recognition (OCR) technology can then be used to convert the image of the content to textual data.

In some embodiments, data collection module 416 can collect the historical field support data and other information about the organization's historical field service dispatches from one or more of the various data sources on a continuous or periodic basis (e.g., according to a predetermined schedule specified by the organization). Additionally or alternatively, data collection module 416 can collect the historical field support data and other information about the organization's historical field service dispatches from one or more of the various data sources in response to an input. For example, a user of service dispatch management service 408 can use their client 402 and issue a request to collect historical field support data. The request may indicate a past period for the historical field support data. In response, data collection module 416 can collect the historical field support data and other information about the organization's historical field service dispatches for the indicated past period from the one or more data sources.

Training dataset generation module 420 is operable to generate (or “create”) a training dataset for use in generating (e.g., training, testing, etc.) an ML model (e.g., a regression-based ML model) to predict a dispatch duration for a field service dispatch. Training dataset generation module 420 can retrieve from data repository 418 a corpus of historical field support data from which to generate the training dataset. The amount of historical field support data to retrieve and use to generate the training dataset may be configured as part of the organization's policy or a user preference.

To generate a training dataset, training dataset generation module 420 may preprocess the retrieved corpus of historical field support data to be in a form that is suitable for training and testing the ML model (e.g., a regression-based ML model). In one embodiment, training dataset generation module 420 may utilize natural language processing (NLP) algorithms and techniques to preprocess the retrieved historical field support data. For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stop words removal, stemming, and/or lemmatization.

The data preprocessing may also include placing the data into a tabular format. In the table, the structured columns represent the features (also called “variables”), and each row represents an observation or instance (e.g., a historical field service dispatch to provide product support for a customer). Thus, each column in the table shows a different feature of the instance. The data preprocessing may also include placing the data (information) in the table into a format that is suitable for training a model (e.g., placing into a format that is suitable for a DNN or other suitable learning algorithm to learn from to generate (or “build”) the ML model, e.g., a regression-based ML model). For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The data preprocessing may also include null data handling (e.g., the handling of missing values in the table). For example, support provided to a product, such as recertification or installation of the product, may not involve replacement and/or repair of any part (component) in the product. In these and similar cases, the historical field support data for the field service dispatch can include missing values. According to one embodiment, null or missing values in a column (a feature) may be replaced by median of the other values in that column. For example, median imputation may be performed using a median imputation technique such as that provided by Scikit-learn (Sklearn). According to alternative embodiments, observations in the table with null or missing values in a column may be replaced by a mode or mean value of the values in that column or removed from the table.

The data preprocessing may also include feature selection and/or data engineering to determine or identify the relevant or important features from the noisy data (e.g., the unnecessary features and the features that are highly correlated). The relevant/important features are the features that are more correlated with the thing being predicted by the trained model (e.g., a dispatch duration for a field service dispatch). A variety of feature engineering techniques, such as exploratory data analysis (EDA) and/or bivariate data analysis with multivariate-variate plots and/or correlation heatmaps and diagrams, among others, may be used to determine the relevant features. For example, for a particular historical field service dispatch to provide product support for a customer, the relevant features may include important features from the field support data such as the product being supported, type of product, customer and location of the support, parts being replaced/fixed, the field engineer's expertise, and the field engineer's history in providing the specific support, among others.

The data preprocessing can include adding an informative label to each instance in the training dataset. As explained above, each instance in the training dataset represents a historical field service dispatch in the organization (e.g., a historical field service dispatch made by the organization to provide product support for a customer). In some implementations, a label (e.g., a dispatch duration) can be added to each instance in the training dataset. The label added to each instance, i.e., the label added to each historical field service dispatch, is a representation of a prediction for that instance in the training dataset (e.g., the thing being predicted) and helps a machine learning model learn to make the prediction when encountered in data without a label. For example, for a given field service dispatch, the added label may indicate a dispatch duration (e.g., actual time taken to provide the product support).

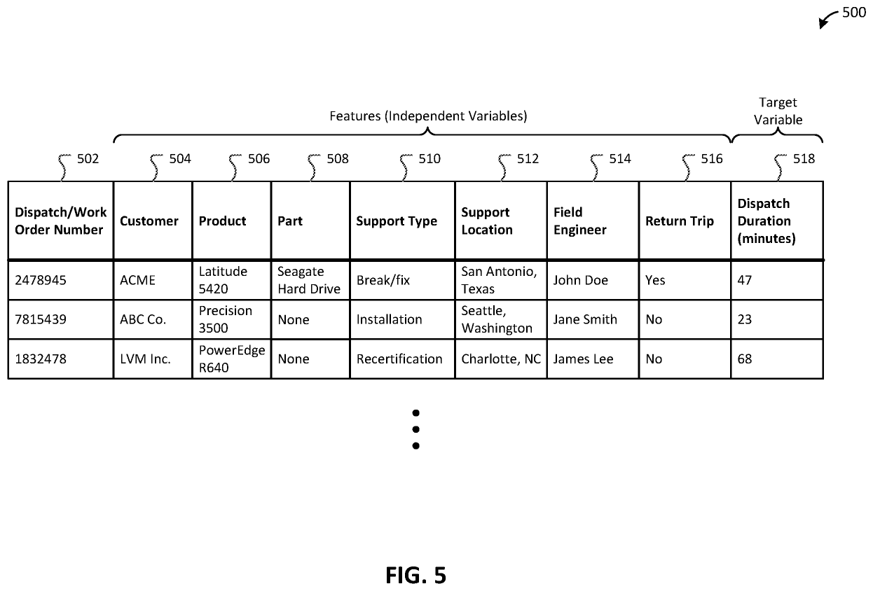

Each instance in the table may represent a training/testing sample (i.e., an instance of a training/testing sample) in the training dataset and each column may be a relevant feature of the training/testing sample. As previously described, each training/testing sample may correspond to a historical field service dispatch made by the organization to provide product support for a customer. In a training/testing sample, the relevant features are the independent variables and the things being predicted (e.g., a dispatch duration) is the dependent variable (e.g., label). In some embodiments, the individual training/testing samples may be used to generate a feature vector, which is a multi-dimensional vector of elements or components that represent the features in a training/testing sample. In such embodiments, the generated feature vectors may be used for training or testing an ML model using supervised learning to make the prediction. Examples of relevant features of a training dataset for training/testing the ML model for predicting a dispatch duration for a field service dispatch are provided below with respect to FIG. 5.

In some embodiments, training dataset generation module 420 may reduce the number of features in the training dataset. For example, since the training dataset is being generated from the corpus of historical field support data, the number of features (or input variables) in the dataset may be very large. The large number of input features can result in poor performance for machine learning algorithms. For example, in one embodiment, training dataset generation module 420 can utilize dimensionality reduction techniques, such as principal component analysis (PCA), to reduce the dimension of the training dataset (e.g., reduce the number of features in the dataset), hence improving the model's accuracy and performance.

In some embodiments, training dataset generation module 420 can generate the training dataset on a continuous or periodic basis (e.g., according to a predetermined schedule specified by the organization). Additionally or alternatively, training dataset generation module 420 can generate the training dataset in response to an input. For example, a user of service dispatch management service 408 can use their client 402 and issue a request to generate a training dataset. In response, training dataset generation module 420 can retrieve the historical field support data for generating the training dataset from data repository 418 and generate the training dataset using the retrieved historical field support data. Training dataset generation module 420 can store the generated training dataset within data repository 418, where it can subsequently be retrieved and used (e.g., retrieved and used to build an ML model for predicting a dispatch duration for a field service dispatch).

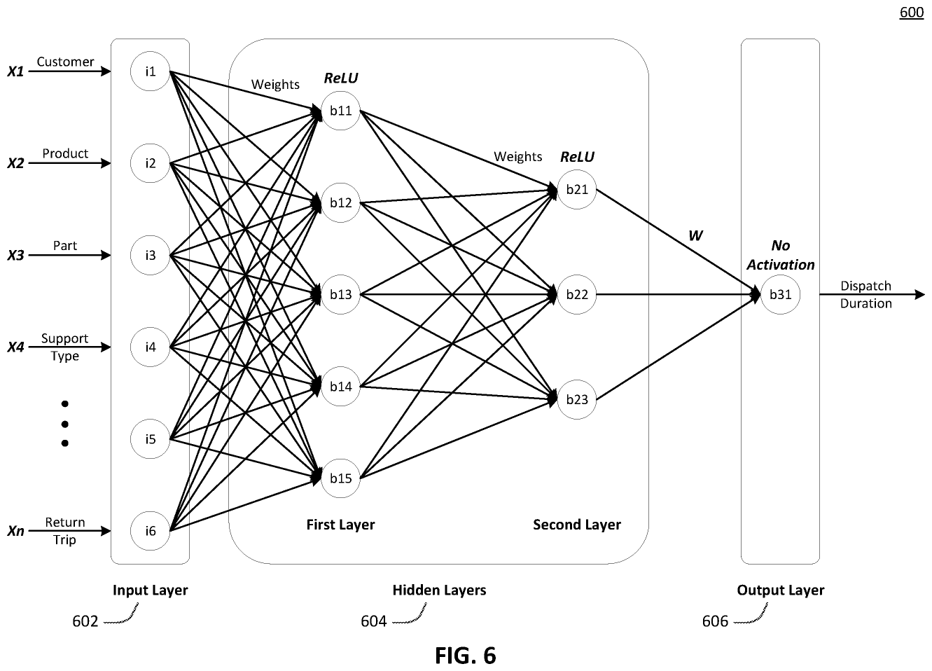

Still referring to service dispatch management service 408, service dispatch management module 422 is operable to predict dispatch durations for field service dispatches. In other words, service dispatch management module 422 is operable to, for an input of information about a field service dispatch (e.g., a new field service dispatch that is being scheduled), predict a dispatch duration for the field service dispatch. In some embodiments, service dispatch management module 422 can include an ML algorithm, such as a DNN, trained to output a regression response using a training dataset generated from the organization's historical field support data. The training dataset may be retrieved from data repository 418. Once the ML model is trained, the output regression response can be a prediction of a dispatch duration for a field service dispatch. For example, in response to input of information about a new field service dispatch for a customer, the ML model can predict a dispatch duration for the new field service dispatch based on the learned behaviors (or “trends”) in the training dataset. Further description of the training of the ML algorithm (e.g., a DNN) and which can be implemented within service dispatch management module 422 is provided below at least with respect to FIG. 6.

In some embodiments, service dispatch management module 422 can send or otherwise provide the predicted dispatch duration for the field service dispatch to field service management system 428. For example, service dispatch management module 422 can use an API provided by field service management system 428 to send information about the predicted dispatch duration for the field service dispatch.

Referring now to FIG. 5 and with continued reference to FIG. 4, shown is a diagram illustrating a portion of a data structure 500 that can be used to store information about relevant features of a training dataset for training a machine learning (ML) model to predict a dispatch duration for a field service dispatch, in accordance with an embodiment of the present disclosure. For example, the training dataset including the illustrated features, as well as other features generated from historical field support data, may be used to train a DNN to predict a dispatch duration for a field service dispatch. The historical field support data includes the actual product support duration time of each customer that received the product support. As can be seen in FIG. 5, data structure 500 may be in a tabular format in which the structured columns represent the different relevant features (variables) regarding the historical field support data and a row represents individual historical field service dispatches of the organization. The relevant features illustrated in data structure 500 are merely examples of features that may be extracted from the historical field support data and used to generate a training dataset and should not be construed to limit the embodiments described herein.

As shown in FIG. 5, the relevant features may include a dispatch/work order number 502, a customer 504, a product 506, a part 508, a support type 510, a support location 512, a field engineer 514, a return trip 516, and a dispatch duration 518. Dispatch/work order number 502 identifies the historical field service dispatch. Customer 504 indicates a customer associated with the historical field service dispatch (e.g., the customer for whom the field service dispatch to provide the product support was scheduled). Product 506 indicates a type of product associated with the historical field service dispatch (e.g., the type of product, e.g., product model or identification, that was supported during the field service dispatch). Part 508 indicates any part (or “component”) of the product that was serviced (e.g., fixed, replaced, etc.) during the field service dispatch. Support type 510 indicates a type of product support associated with the historical field service dispatch (e.g., the type of support, e.g., break/fix, installation, recertification, etc., which was provided to the product during the field service dispatch). Support location 512 indicates a geographic location associated with the historical field service dispatch (e.g., the geographic location at which the organization provided the product support). Field engineer 514 indicates a field service engineer associated with the historical field service dispatch (e.g., the field service engineer who provided the product support). Return trip 516 indicates a type of trip associated with the historical field service dispatch (e.g., whether the field service dispatch is a first or initial trip to the customer location or a return trip to the customer location to provide the product support, e.g., “Yes”=return trip; “No”=not a return trip). Dispatch duration 518 indicates the duration of the field service (e.g., actual time, e.g., number of minutes, taken to provide the product support).

In data structure 500, each row may represent a training/testing sample (i.e., an instance of a training/testing sample) in the training dataset, and each column may show a different relevant feature of the training/testing sample. In some embodiments, the individual training/testing samples may be used to generate a feature vector, which is a multi-dimensional vector of elements or components that represent the features in a training/testing sample. In such embodiments, the generated feature vectors may be used for training/testing an ML model (e.g., a regression-based ML model of service dispatch management module 422) to predict a dispatch duration for a field service dispatch (e.g., a new field service dispatch that is being scheduled). The features customer 504, product 506, part 508, support type 510, support location 512, field engineer 514, and return trip 516 may be included in a training/testing sample as the independent variables, and dispatch duration 518 included as a dependent variable (a target variable) in the training/testing sample. That is, dispatch duration 518 can be understood as the label added to the individual training/testing samples. The illustrated independent variables are features that influence performance of the ML model (i.e., features that are relevant (or influential) in predicting a dispatch duration for a field service dispatch).

Referring now to FIG. 6 and with continued reference to FIGS. 4 and 5, illustrated is an example architecture of a deep neural network (DNN) for service dispatch management module 422 of FIG. 4, in accordance with an embodiment of the present disclosure. In brief, a DNN includes an input layer for all input variables, multiple hidden layers for feature extraction, and an output layer. Each layer may be comprised of a number of nodes or units embodying an artificial neuron (or more simply a “neuron”). As a DNN, each neuron in a layer receives an input from all the neurons in the preceding layer. In other words, every neuron in each layer is connected to every neuron in the preceding layer and the succeeding layer. As a regression model, the output layer is comprised of a single neuron, which outputs a numerical value representing a dispatch duration for a field service dispatch (e.g., a prediction of a number of minutes to schedule for a field service dispatch).

In more detail, and as shown in FIG. 3, a DNN 600 includes an input layer 602, one or more hidden layers 604 (e.g., two hidden layers), and an output layer 606. Input layer 602 may be composed of a number of neurons to match (i.e., equal to) the number of input variables (independent variables). Taking as an example the independent variables illustrated in data structure 500 of FIG. 5, input layer 602 may include seven (7) neurons to match the seven (7) independent variables (e.g., customer 504, product 506, part 508, support type 510, support location 512, field engineer 514, and return trip 516), where each neuron in input layer 602 receives a respective independent variable. Each succeeding layer (e.g., a first hidden layer and a second hidden layer) in hidden layers 604 can comprise an arbitrary number of neurons, which may depend on the number of neurons included in input layer 602. Each neuron in the first hidden layer of hidden layers 604 receives an input from all the neurons in input layer 602. Each neuron in the second hidden layer of hidden layers 604 receives an input from all the neurons in the first hidden layer of hidden layers 604. As a regression model, output layer 606 includes a single neuron, which receives an input from all the neurons in the second hidden layer of hidden layers 604.

Although FIG. 6 shows hidden layers 604 composed of only two layers, it will be understood that hidden layers 604 may be composed of a different number of hidden layers. Also, the number of neurons shown in the first hidden layer and in the second hidden layer of hidden layers 604 is for illustration only, and it will be understood that actual numbers of neurons in the first hidden layer and in the second hidden layer of hidden layers 604 may be based on the number of neurons in input layer 602.

Each neuron in hidden layers 604 may be associated with an activation function. For example, according to one embodiment, the activation function for the neurons in hidden layers 604 may be a rectified linear unit (ReLU) activation function. As DNN 600 is to function as a regression model, the neuron in output layer 606 will not contain an activation function.

As mentioned previously, as a DNN, each neuron in the different layers may be coupled to one another. Each coupling (i.e., each interconnection) between two neurons may be associated with a weight, which may be learned during a learning or training phase. Each neuron may also be associated with a bias factor, which may also be learned during a training process.

During a first pass (epoch) in the training phase, the weight and bias values may be set randomly by the neural network. For example, according to one embodiment, the weight and bias values may all be set to 1 (or 0). Each neuron may then perform a linear calculation by combining the multiplication of each input variables (x1, x2, . . . ) with their weight factors and then adding the bias of the neuron. The equation for this calculation may be as follows:

$$ws 1 = x 1. w 1 + x 2. w 2 + … + b 1 ,$$

where ws1 is the weighted sum of the neuron1, x1, x2, etc. are the input values to the model, w1, w2, etc. are the weight values applied to the connections to the neuron1, and b1 is the bias value of neuron1. This weighted sum is input to an activation function (e.g., ReLU) to compute the value of the activation function. The weighted sum and activation function values of all the other neurons in a layer are similarly calculated. These values are then fed to the neurons of the succeeding (next) layer. The same process is repeated in the succeeding layer neurons until the values are fed to the neuron of output layer 606. Here, the weighted sum may also be calculated and compared to the actual target value. Based on the difference, a loss value can be calculated. The loss value indicates the extent to which the model is trained (i.e., how well the model is trained). This pass through the neural network is a forward propagation, which calculates the error and drives a backpropagation through the network to minimize the loss or error at each neuron of the network. Considering the error/loss is generated by all the neurons in the network, backpropagation goes through each layer from back to forward and attempts to minimize the loss using an optimization mechanism such as, for example, a gradient descent-based optimization mechanism or some other optimization method. Since the neural network is used as a regressor, mean squared error may be used as the loss function and adaptive movement estimation (Adam) used as the optimization algorithm.

The result of this backpropagation is used to adjust (update) the weight and bias values at each connection and neuron level to reduce the error/loss. An epoch (one pass of the entire training dataset) is completed once all the observations of the training data are passed through the neural network. Another forward propagation (e.g., epoch 2) may then be initiated with the adjusted weight and bias values and the same process of forward and backpropagation may be repeated in the subsequent epochs. Note that a higher loss value means the model is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train the model. In any case, once the loss is reduced to a very small number (ideally close to zero (0)), the neural network is sufficiently trained for prediction.

For example, a DNN 600 can be built by first creating a shell model and then adding a desired number of individual layers to the shell model. For each layer, the number of neurons to include in the layer can be specified along with the type of activation function to use and any kernel parameter settings. Once DNN 600 is built, a loss function (e.g., mean squared error), an optimizer algorithm (e.g., Adam), and validation metrics (e.g., mean squared error (mse); mean absolute error (mae)) can be specified for training, validating, and testing DNN 600.

DNN 600 can then be trained by passing the portion of the training dataset designated for training (e.g., 70% of the training dataset designated as the training dataset) and specifying a number of epochs. An epoch (one pass of the entire training dataset) is completed once all the observations of the training data are passed through DNN 600. DNN 600 can be validated once DNN 600 completes the specified number of epochs. For example, DNN 600 can process the training dataset and the loss/error value can be calculated and used to assess the performance of DNN 600. The loss value indicates how well DNN 600 is trained. Note that a higher loss value means DNN 600 is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train DNN 600. In any case, once the loss is reduced to a very small number (ideally close to 0), DNN 600 is sufficiently trained for prediction. Prediction of the model (e.g., DNN 600) can be achieved by passing the independent variables of testing samples in the testing dataset (i.e., for comparing train vs. test) or the real values of a field service dispatch for a customer to predict a dispatch duration for the field service dispatch.

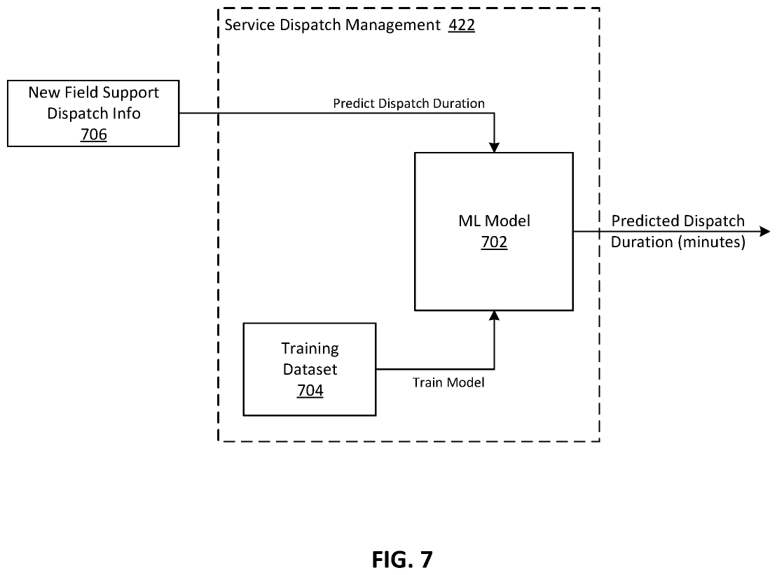

Referring now to FIG. 7, in which like elements of FIG. 4 are shown using like reference designators, shown is a diagram of an example topology that can be used to predict a dispatch duration for a field service dispatch, in accordance with an embodiment of the present disclosure. As shown in FIG. 7, service dispatch management module 422 includes an ML model 702. In some embodiments, ML model 702 may correspond to DNN 600 of FIG. 6. ML model 702 can be trained and tested using machine learning techniques with a training dataset 704. Training dataset 704 can be retrieved from a data repository (e.g., data repository 418 of FIG. 4). As described previously, training dataset 704 for ML model 702 may be generated from a corpus of historical field support data. Once ML model 702 is sufficiently trained, service dispatch management module 422 can, in response to receiving information regarding a field service dispatch (e.g., a new field service dispatch for a customer), predict a dispatch duration for the field service dispatch. For example, as shown in FIG. 7, a feature vector 706 that represents a field service dispatch, such as some or all the variables that may influence the prediction of a dispatch duration, may be determined and input, passed, or otherwise provided to the trained ML model 702. In some embodiments, the input feature vector 706 (e.g., the feature vector representing the field service dispatch) may include some or all the relevant features which were used in training ML model 702. In response to the input, the trained ML model 702 can output a regression response which is a prediction of a dispatch duration for the field service dispatch.

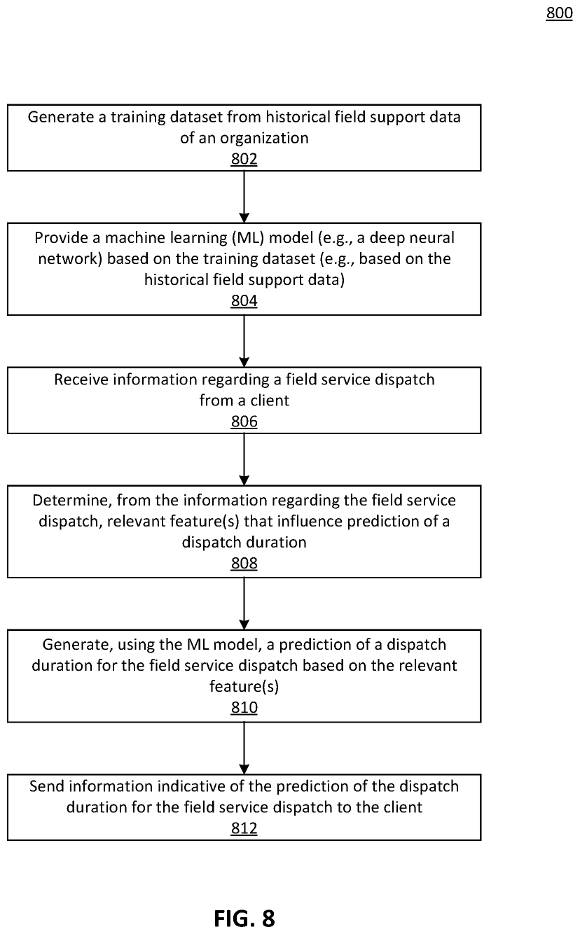

FIG. 8 is a flow diagram of an example process 800 for prediction of a dispatch duration for a field service dispatch, in accordance with an embodiment of the present disclosure. Illustrative process 800 may be implemented, for example, within system 400 of FIG. 4. In more detail, process 800 may be performed, for example, in whole or in part by data collection module 416, training dataset generation module 420, and service dispatch management module 422, or any combination of these including other components of system 400 described with respect to FIG. 4.

With reference to process 800 of FIG. 8, at 802, a training dataset for use in training an ML model may be generated from historical field support data of an organization. For example, data collection module 416 may collect the historical field support data from one or more data sources used by the organization to store or maintain such information/data and store the collected historical field support data within data repository 418. Training dataset generation module 420 can then retrieve a corpus of the historical field support data from data repository 418, generate the training dataset, as previously described herein, and store the training dataset within data repository 418.

At 804, an ML model trained or configured using the training dataset generated from some or all the collected historical field support data may be provided. For example, an ML algorithm that supports outputting a regression response may be trained and tested using the training dataset (e.g., training dataset generated by training dataset generation module 420) to build the ML model. For example, in one implementation, service dispatch management module 422 may retrieve the training dataset from data repository 418 and use the training dataset to train a DNN, as previously described herein. The trained ML model can, in response to receiving information regarding a field service dispatch (e.g., a new field service dispatch for a customer), output a regression response (e.g., a prediction of a dispatch duration for the field service dispatch).

At 806, information regarding a field service dispatch may be received. For example, the information regarding the field service dispatch may be received along with a request for an estimate of a dispatch duration for the field service dispatch from a client (e.g., client 402 of FIG. 4). The field service dispatch specified in the request may be a new field service dispatch that is being scheduled. In response to the information regarding the field service dispatch (e.g., the new field service dispatch that is being scheduled) being received, at 808, relevant feature(s) that influence a prediction of a dispatch duration may be determined from the received information regarding the field service dispatch. For example, in one implementation, service dispatch management module 422 may determine the relevant feature(s) that influence prediction of a dispatch duration, as previously described herein.

At 810, a prediction of a dispatch duration for the field service dispatch may be generated. For example, service dispatch management module 422 may generate a feature vector that represents the relevant feature(s) of the field service dispatch specified in the request. Service dispatch management module 422 can then input the generated feature vector to the ML model (e.g., DNN), which outputs a prediction of a dispatch duration for the input field service dispatch. The prediction generated using the ML model is based on the relevant feature(s) input to the ML model. The prediction by the ML model is based on the learned behaviors (or “trends”) in the training dataset used in training the ML model.

At 812, information indicative of the prediction of the dispatch duration for the field service dispatch specified in the request may be sent or otherwise provided to the client and presented to a user (e.g., the user who sent the request for an estimate of a dispatch duration for the field service dispatch). For example, the information indicative of the prediction may be presented within a user interface of a client application on the client. The user can then take one or more appropriate actions based on the provided prediction (e.g., schedule a field service dispatch for the customer for the predicted dispatch duration).

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, information regarding a field service dispatch from another computing device;
determining, by the computing device, one or more relevant features from the information regarding the field service dispatch, the one or more relevant features influencing prediction of a dispatch duration;
generating, by the computing device using a machine learning (ML) model, a prediction of a dispatch duration for the field service dispatch based on the determined one or more relevant features; and
sending, by the computing device, the prediction of the dispatch duration for the field service dispatch to the another computing device.

2. The method of claim 1, wherein the ML model includes a deep neural network (DNN).

3. The method of claim 2, wherein the DNN predicts a regression response, wherein the regression response is the prediction of the dispatch duration for the field service dispatch.

4. The method of claim 1, wherein the ML model is generated using a training dataset generated from a corpus of historical field support data of an organization.

5. The method of claim 4, wherein the training dataset comprises a plurality of training/testing samples, wherein each training/testing sample of the plurality of training/testing samples includes one or more features extracted from the historical field support data, wherein the one or more features includes a feature indicative of a customer associated with the field service dispatch.

6. The method of claim 4, wherein the training dataset comprises a plurality of training/testing samples, wherein each training/testing sample of the plurality of training/testing samples includes one or more features extracted from the historical field support data, wherein the one or more features includes a feature indicative of a type of product associated with the field service dispatch.

7. The method of claim 4, wherein the training dataset comprises a plurality of training/testing samples, wherein each training/testing sample of the plurality of training/testing samples includes one or more features extracted from the historical field support data, wherein the one or more features includes a feature indicative of a type of support associated with the field service dispatch.

8. The method of claim 4, wherein the training dataset comprises a plurality of training/testing samples, wherein each training/testing sample of the plurality of training/testing samples includes one or more features extracted from the historical field support data, wherein the one or more features includes a feature indicative of a support location associated with the field service dispatch.

9. The method of claim 4, wherein the training dataset comprises a plurality of training/testing samples, wherein each training/testing sample of the plurality of training/testing samples includes one or more features extracted from the historical field support data, wherein the one or more features includes a feature indicative of a field support engineer associated with the field service dispatch.

10. The method of claim 4, wherein the training dataset comprises a plurality of training/testing samples, wherein each training/testing sample of the plurality of training/testing samples includes one or more features extracted from the historical field support data, wherein the one or more features includes a feature indicative of a type of trip associated with the field service dispatch.

11. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving information regarding a field service dispatch from a computing device;
determining one or more relevant features from the information regarding the field service dispatch, the one or more relevant features influencing prediction of a dispatch duration;
generating, using a machine learning (ML) model, a prediction of a dispatch duration for the field service dispatch based on the determined one or more relevant features; and
sending the prediction of the dispatch duration for the field service dispatch to the computing device.

12. The system of claim 11, wherein the ML model includes a deep neural network (DNN).

13. The system of claim 12, wherein the DNN predicts a regression response, wherein the regression response is the prediction of the dispatch duration for the field service dispatch.

14. The system of claim 11, wherein the ML model is generated using a training dataset generated from a corpus of historical field support data of an organization.

15. The system of claim 14, wherein the training dataset comprises a plurality of training/testing samples, wherein each training/testing sample of the plurality of training/testing samples includes one or more features extracted from the historical field support data, wherein the one or more features includes a feature indicative of one of a customer associated with the field service dispatch, a type of product associated with the field service dispatch, a type of support associated with the field service dispatch, a support location associated with the field service dispatch, a field support engineer associated with the field service dispatch, or a type of trip associated with the field service dispatch.

16. A non-transitory machine-readable medium encoding instructions that when executed by one or more processors cause a process to be carried out, the process including:
receiving information regarding a field service dispatch from a computing device;
determining one or more relevant features from the information regarding the field service dispatch, the one or more relevant features influencing prediction of a dispatch duration;
generating, using a machine learning (ML) model, a prediction of a dispatch duration for the field service dispatch based on the determined one or more relevant features; and
sending the prediction of the dispatch duration for the field service dispatch to the computing device.

17. The machine-readable medium of claim 16, wherein the ML model includes a deep neural network (DNN).

18. The machine-readable medium of claim 17, wherein the DNN predicts a regression response, wherein the regression response is the prediction of the dispatch duration for the field service dispatch.

19. The machine-readable medium of claim 16, wherein the ML model is generated using a training dataset generated from a corpus of historical field support data of an organization.

20. The machine-readable medium of claim 19, wherein the training dataset comprises a plurality of training/testing samples, wherein each training/testing sample of the plurality of training/testing samples includes one or more features extracted from the historical field support data, wherein the one or more features includes a feature indicative of one of a customer associated with the field service dispatch, a type of product associated with the field service dispatch, a type of support associated with the field service dispatch, a support location associated with the field service dispatch, a field support engineer associated with the field service dispatch, or a type of trip associated with the field service dispatch.
